(19) United States
(12) Patent Application Publication
(10) Pub. No.: US 2012/0310717 A1
(43) Pub. Date: Dec. 6, 2012

(54) METHOD AND APPARATUS FOR CONTROLLING A PERSPECTIVE DISPLAY OF ADVERTISEMENTS USING SENSOR DATA

(75) Inventor: Mikko Tapio Kankainen, Helsinki (FI)

(73) Assignee: Nokia Corporation, Espoo (FI)

(21) Appl. No.: 13/483,939

(22) Filed: May 30, 2012

Related U.S. Application Data
(60) Provisional application No. 61/491,695, filed on May 31, 2011.

(51) Int. Cl. G06Q 30/02

(52) U.S. Cl. 705/14.4

(57) ABSTRACT

An approach is provided for controlling perspective display of advertisement using sensor data. The advertising engine causes, at least in part, a presentation of at least one advertisement banner at a device, the advertisement banner including at least one perspective display of one or more advertisement items. The advertising engine determines positional information based, at least in part, on one or more sensors associated with the device. The advertising engine processes and/or facilitates a processing of the positional information to cause, at least in part, a rendering of the at least one perspective display, the one or more advertisement items, or a combination thereof in the at least one advertisement banner.

### RELATED APPLICATIONS

This application claims the benefit of the earlier filing date under 35 U.S.C. §119(e) of U.S. Provisional Application Ser. No. 61/491,695 filed May 31, 2011, entitled “Method and Apparatus for Controlling a Perspective Display of Advertisements Using Sensor Data,” the entirety of which is incorporated herein by reference.

### BACKGROUND

Service providers and device manufacturers (e.g., wireless, cellular, etc.) are continually challenged to deliver value and convenience to consumers by, for example, providing compelling network services. These network services may generate revenue from the network services by presenting advertisements to users of the services. Examples of network services include messaging services, maps and navigation services, social networking services, media services, purchasing services, gaming services, and the like. Advertisements are embedded in web pages and applications, and/or placed onto objects within the web pages and applications. However, the advertisements are easily ignored by the users due to lack of interactivity to users' actions, especially physical movements. Device manufacturers and service providers face significant challenges to increase advertisement interactions.

### SOME EXAMPLE EMBODIMENTS

Therefore, there is a need for an approach for controlling the perspective display of advertisements using sensor data.

According to one embodiment, a method comprises causing, at least in part, a presentation of at least one advertisement banner at a device, the advertisement banner including at least one perspective display of one or more advertisement items. The method also comprises determining positional information based, at least in part, on one or more sensors associated with the device. The method further comprises processing and/or facilitating a processing of the positional information to cause, at least in part, a rendering of the at least one perspective display, the one or more advertisement items, or a combination thereof in the at least one advertisement banner.

According to another embodiment, an apparatus comprises at least one processor, and at least one memory including computer program code for one or more programs, the at least one memory and the computer program code configured to, with the at least one processor, cause, at least in part, the apparatus to present at least one advertisement banner at a device, the advertisement banner including at least one perspective display of one or more advertisement items. The apparatus is also caused to determine positional information based, at least in part, on one or more sensors associated with the device. The apparatus is further caused to process and/or facilitate a processing of the positional information to cause, at least in part, a rendering of the at least one perspective display, the one or more advertisement items, or a combination thereof in the at least one advertisement banner.

According to another embodiment, a computer-readable storage medium carries one or more sequences of one or more instructions which, when executed by one or more processors, cause, at least in part, an apparatus to present at least one advertisement banner at a device, the advertisement banner including at least one perspective display of one or more advertisement items. The apparatus is also caused to determine positional information based, at least in part, on one or more sensors associated with the device. The apparatus is further caused to process and/or facilitate a processing of the positional information to cause, at least in part, a rendering of the at least one perspective display, the one or more advertisement items, or a combination thereof in the at least one advertisement banner.

According to another embodiment, an apparatus comprises means for causing, at least in part, a presentation of at least one advertisement banner at a device, the advertisement banner including at least one perspective display of one or more advertisement items. The apparatus also comprises means for determining positional information based, at least in part, on one or more sensors associated with the device. The apparatus further comprises means for processing and/or facilitating a processing of the positional information to cause, at least in part, a rendering of the at least one perspective display, the one or more advertisement items, or a combination thereof in the at least one advertisement banner.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of controlling a perspective display of advertisements using sensor data, according to one embodiment;

FIG. 2 is a diagram of the components of an advertising engine, according to one embodiment;

FIG. 3 is a flowchart of controlling a perspective display of advertisements using sensor data, according to one embodiment;

FIGS. 4A-4C are diagrams of user interfaces utilized in the process of FIG. 3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for controlling a perspective display of advertisements using sensor data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

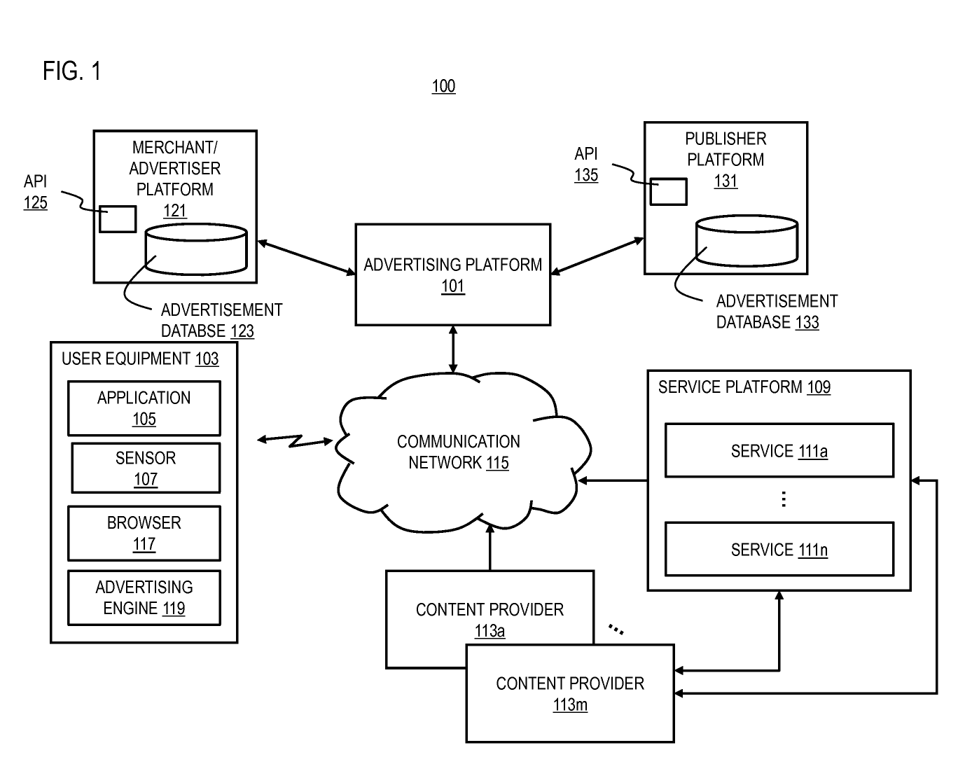

FIG. 1 is a diagram of a system capable of controlling a perspective display of advertisements using sensor data, according to one embodiment. As noted previously, service providers and device manufacturers may generate revenue or otherwise promote additional services, features, products, etc., by presenting advertisements on user devices. Advertisements generally may be presented in association with various applications and/or services such as messaging, navigation, maps, social networking, media (e.g., video, audio, images, etc.), games, stores, etc. For example, a map application may display, in a portion of a graphical user interface, a street view augmented with an advertisement, such as location-based pop-ups or billboards. However, the traditional augmented pop-ups or billboards are of a fixed size with limited user interactivity. The user is only allowed to manually select (e.g., clicking, touching, typing, etc.) a pop-up or billboard to get more information via, for example, opening a new webpage, etc. There is a need of a new way for a user to interact with advertisements on the user device, to enhance user experience.

To address this problem, a system 100 of FIG. 1 introduces an advertising platform 101 with the capability to control a perspective display of advertisements and related information (e.g., discount information, coupons, offers, promotions, other marketing materials, etc.) using sensor data. The advertisements may be served in any formats, such as banner advertisements, location-based advertisements, in-application advertisements, event or situational advertisements, etc., to user devices.

As shown in FIG. 1, the system 100 comprises user equipment (UE) 103 having connectivity to an advertising platform 101, a service platform 109, and content providers 113a-113m via a communication network 115. In the illustrated embodiment, the UE 103 includes one or more applications 105, one or more sensors 107, a browser 117, and an advertising engine 119. The advertising engine 119 provides components that enable the serving of advertisements of multiple formats (e.g., banners advertisements, location-based advertisements, in-application advertisements, event or situational advertisements, etc.) via, for instance, the application 105 and/or the browser 117. In one embodiment, the application 105 is a client for at least one of the services 111a-111n of the service platform 109. In one embodiment, the application 105 is script delivered through the browser 117. In one embodiment, the advertisements and/or content files for serving the advertisements can be specified by and/or obtained from the service platform 109, the services 111a-111n of the service platform 109, the content providers 113a-113m, and/or other components such as the advertising platform 101 or the merchant/advertiser platform 121 (discussed in more detail below).

In one embodiment, the sensors 107 determine, for instance, the local context of the UE 103 and any user thereof, such as a local time, geographic position from a positioning system, ambient temperature, pressures, sound and light, etc. The sensor data can be use by the advertising engine 119 to support interactions with advertisements shown on a user interface of the UE 103.

The UE 103 and/or the sensors 107 are used to minimize the user's manual selection using traditional input methods, such as screens, keyboards, pens, etc. by clicking, touching, typing, etc. In one embodiment, the UE 103 has a built-in accelerometer for detecting motions. The motion data is used for controlling the perspective display of advertisements, including orientation of objects in an advertisement banner. In one embodiment, the sensors 107 collect motion signals by an accelerometer, a gyroscope, a compass, a GPS device, other motion sensors, or combinations thereof. The motion signals can be used independently or in conjunction with the images to control the perspective display of advertisement items using sensor data. Available sensor data such as location information, compass bearing, etc. are stored as metadata, for example, in an image exchangeable image file format (Exif).

By way of example, the UE 103 shows on its screen a 3D advertisement banner of a baseball stadium that changes perspective as the user is walking toward purchased seats in the stadium. As the user moves, the 3D advertisement banner shows an avatar of the user in the map as well as pop-ups of advertisement items (e.g., items available in the stadium such as fast food, gift shops, vending machines, etc.) in the proximity of the UE 103. The perspective view of each pop-up changes along with the movement of the UE 103 to be bigger in size and closer to the front view. In addition, the content within each pop-up can change as the UE 103 moves closer, such as providing more detailed information about the corresponding advertisement item (e.g., displaying a menu or the interior of an advertised fast food restaurant).

In one embodiment, the advertising engine 119 presents an advertisement banner with an advertisement item in which a perspective display is shown with respect to the UE 103's location, profile information (e.g., demographics, preferences), and other context information (e.g., activity, time, etc.). The user can be presented with related offers in the form of in-application advertisements). For example, the in-application advertisements or the application serving the advertisements can exploit context-aware interfaces to affect, for instance, how, when, what, etc. Advertisements are presented based, at least in part, on the context of user situations, needs, friend network recommendations, location search results, click history, etc.

In one embodiment, the advertising engine 119 presents an advertisement banner with a single advertisement item, product, service, business, or a combination thereof. For example, an advertiser buys advertising rights so that only its product(s) are displayed in a particular perspective-based advertisement banner described herein. In this case, as the UE 103 moves, the view in the advertisement banner changes accordingly to highlight locations associated with the advertised product or item. In some cases, where the product is outside of the current field of view of the advertisement banner, an indicator can be presented to point in the direction of the product. In this way, the perspective-based advertisement banner can provide an advertising experience that can dynamically interact with the motions of the user to indicate locations where advertised products can be found. By way of example, a restaurant runs an advertisement banner that includes a live camera view as the background of the banner and a pointer to indicate the direction to the restaurant.

In another embodiment, the advertising engine 119 presents a category-based advertisement banner that is associated with a particular category of advertisement items. In this case, multiple advertisers with products falling within the category can be presented in the perspective display of the advertisement banner. For example, the producer of the advertisement banner can defined a specific category such as “coffee shops”, then the coffee shops that have advertising rights to the banner can be displayed. In many cases, however, it is contemplated that the more common advertisement banner will be for exclusive single product advertisement banners as described above rather than the category-based banners.

In one embodiment, the degrees and forms of presentation interactivity have are limited only based on the types and sources of sensor data available to the UE 103 presenting the advertisement banner. In addition, the presentation interactivity may be customized for particular individuals.

The sensors 107 can be independent devices or incorporated into the UE 103. The sensors 107 may include an accelerometer, a gyroscope, a compass, a GPS device, microphones, touch screens, light sensors, or combinations thereof. The sensors 107 can be a head/ear phone, a wrist device, a pointing device, or a head mounted display. By way of example, the user wears a sensor that is in a headphone and provides directional haptics feedback to determine the position of the ears in a space. The user can wear a head mounted display with sensors to determine the position and the orientation of the user's head and view. The user can wear a device around a belt, a wrist or integrated to a headset. The device gives an indication of the direction of an object of interest in a 3D space using haptics stimulation. The haptics stimulation may use simple haptics patterns to carry more information. For example, a frequency of stimulation indicates how close the user is to the object of interest.

In one embodiment, the UE 103 includes an advertising engine 119. The advertising engine 119 enables the use of the advertising platform 101 (e.g., via an API) and sensor data to present advertisements in the application 105. By way of example, the application 105 may present the advertisements in a portion of a graphical user interface (GUI) associated with the application 105. Further, the advertising platform 101 may control advertisements provided to and/or presented by the applications 105 via the advertising engine 119. As the advertising platform 101 is used to present advertisements, sensor data can be collected by the sensors 107 and then used by the advertising engine 119 to present the advertisement items. In one embodiment, advertisements to be displayed to users of devices can be retrieved from an advertising server, stored in a cache of the device, and presented to the user. The advertising engine 119 can retrieve advertisement items from the cache to present advertisement items within one or more applications. In certain embodiments, an advertising engine is a program and/or hardware resident on a device that can retrieve advertisements from the advertising server and control presentation of the advertisements. The advertising engine 119 can fetch advertisements from an advertising server or platform via an Application Programming Interface (API) to store in the cache for presentation via, for instance, the applications 105. Further, the advertising engine 119 can provide an API for applications running the advertising engine to request advertisements to present.

The user can then respond to the advertisement items, which, in turn, can trigger other related advertisements based on the user's continued interaction. As previously, described the user interactions can be tracked for reporting to merchants/advertisers, publishers, and other entities involved in the advertising process.

When a user requests access to a resource or uses an application, the system 100 initiates displaying an advertisement banner within an application with at least one advertisement item and prompts the user (e.g., “Take Action to Obtain a free soft drink from Fast Foods”) to initiate an interaction with the UE 103 with respect to the advertisement banner and/or the advertisement item, in order to display the advertisement banner and/or the advertisement items differently on the UE 103. The UE 103 initiates sensing and recording interaction between the user and the UE 103, and determines whether the interaction meets one or more criteria for displaying or changing the display of the advertisement item within the advertisement banner. In one embodiment, the UE 103 initiates sensing and recording interaction between the user and a real life object (e.g., a coffee table surface) associated with the advertisement banner and/or the advertisement item or interaction between the UE 103 and the real life object, to determine whether the interaction meets one or more criteria for displaying or changing the display of the advertisement item within the advertisement banner.

When a user is invited to perform a motion/interaction, the UE 103 starts sensors 107 of the UE 103 to record the motion/interaction. Available metadata such as location and compass bearing can be recorded along with the image data and the motion/interaction flow. Location context, device positions and user actions are linked to the perspective display of the advertisement banner and/or the advertisement item embedded therein. This system 100 can be used in conjunction with various applications, such as games, geocaching, augmented reality, and information services. By way of example, a user can speak a tagline (e.g., Nokia's “Connecting People”) or whistle a tune (e.g., the Nokia tune Grande Valse) of a famous company to call out relevant advertisement items in the advertisement banner. As another example, the user can point the UE 103 towards the direction of a Nokia advertisement billboard shown in the advertisement banner to trigger more information of the associated Nokia store.

As used herein, in one embodiment, the user refers to an entity to which the advertisement is presented (e.g., via the UE 103 associated with the user). Moreover, the merchant/advertiser is an entity that creates and/or requests presentation of the advertisements (e.g., as part of a marketing campaign). In one embodiment, the advertising activities of merchant/advertiser is facilitated by the merchant/advertiser platform 121, which includes, for instance, one or more portals, products, services, advertisement databases 123, application programming interfaces (APIs) 125, etc. to support connectivity or access by merchants, advertisers, and the like. As used herein, the publisher/developer is, for instance, a producer, owner, licensee, or other party with the rights for controlling the means through which advertisements are presented in the system 100. By way of example, the means include applications (e.g., an application 105 executing at the UE 103), sensors (e.g., a sensor 107 at the UE 103), services (e.g., a service platform 109, one or more services 111a-111n of the service platform 109), content providers 113a-113m, and other similar entities. In one embodiment, the advertising activities of the publisher/developer are facilitated by the publisher platform 131 which includes, for instance, one or more portals, advertisement databases 133, application programming interfaces (APIs) 135, etc. to support connectivity or access by publishers, developers, content providers, and the like.

More specifically, in one embodiment, the system 100 exposes relevant interfaces (e.g., application programming interfaces (APIs)) to merchants/advertisers, publishers, etc. to target users for presentation of one or more advertisements. In one embodiment, it is contemplated that the advertising platform 101 may serve advertisements that are related to digital and/or physical goods/services and that the merchants/advertisers can be engaged in online commerce, offline commerce, or both. In this way, the advertising platform 101 enables the bridging of online commerce conducted via the UE 103 to offline or physical merchants.

In one embodiment, the system 100 targets users for advertisements based, at least in part, on location-based services used by the users. For example, the system 100 determines when a user initiates a location-based content display (e.g., a street view including places of nearby businesses, retailers, etc.) and serves advertisements to the user based on the places (e.g., augmented billboards). In one embodiment, the corresponding advertisement may be served based on a contractual relationship with the merchant matching the result. For example, the merchant may pay a fee to show its billboard. In another embodiment, the corresponding advertisement may be served based on user preferences with the merchant matching user-set criteria results. For example, the user wants to see all billboards of fast food restaurants. In yet another embodiment, the presentation of advertisements is through one or more products/services of one or more publishers and/or developers.

In one embodiment, the system 100 continues to track and respond to subsequent user interactions with the presentation of the initial location-based advertisement. For example, the system 100 may navigate or otherwise direct the user to the merchant's place of business as presented in the advertisement information. If the user physically goes to the location or place of business, the system 100 may provide additional advertisements, promotions, marketing materials, etc. (e.g., a coupon or other discount information) for use while at the place of business. If the user further interacts by actually using the coupon at the merchant's location or place of business, the system 100 can track this information and provide potentially other advertisements, promotions, offers, etc. related to the merchant or other merchants.

In one embodiment, any of the information about the user experience and interactions with the advertisements can be tracked and reported to the merchant/advertiser and/or publisher/developer. In this way, the merchants and publishers can conduct various analyses of the data to determine, for instance, the effectiveness or success of particular advertising campaigns, etc.

In the illustrated embodiment, a publisher platform 131 is included for publishers/developers of products, including applications for user equipment. For example, the publisher platform 131 exposes self-service interfaces for advertisement campaigns and yields optimization management to enable publishers to reach and engage users (e.g., track and respond to user interaction with publisher products and/or applications). In one embodiment, the publisher platform 131 maintains an advertisement database 133 that includes a product/service data structure that holds data that indicates the products/services offered by a corresponding publisher, as well as advertising inventory (e.g., products/services or applications with advertising space) of the corresponding publishers. In one embodiment, the products/services may be provided through the service platform 109, the services 111a-111m, and/or the content providers 113a-113m and are thus associated with a publisher. In addition, or alternatively, the products/services may be stored and/or delivered from the data structure. In one embodiment, the publisher platform 131 also provides access to analytical reports generated by the advertising platform 101 to publishers/developers. In one embodiment, access to the information on the advertisement database 133 is controlled to only privileged services (e.g., the advertising platform 101 and other authorized users). In some embodiments, access is obtained through an API 135.

As shown, the system 100 includes a merchant/advertiser platform 121 for providing access to the functions of the advertising platform 101 to merchants and other advertisers. For example, the merchant/advertiser platform 121 provides self-service interfaces to enable merchants and/or advertisers to register their listing for location-based results (e.g., a place or point of interest), buy advertisements and search placements, access reporting metrics, etc. In one embodiment, the merchant/advertiser platform 121 maintains an advertisement database 123 for storing advertisements, criteria for targeted users, advertising campaigns, coupons, and other related information. In one embodiment, the content information (e.g., media files, graphics, etc.) for the advertisements may be obtained from or provided directly by the service platform 109, the services 111a-111n, and/or the content providers 113a-113m. In one embodiment, the merchant/advertiser platform 121 also provides access to analytical reports generated by the advertising platform 101 to merchants/developers. In one embodiment, access to the information on the advertisement database 125 is controlled to only privileged services (e.g., the advertising engine 119). In some embodiments, access is obtained through an API 125.

In one embodiment, the merchant/advertiser platform 121 may be used to update the advertisements and related advertising content (e.g., specify new advertisements, target demographics or users, dates of advertisements, etc.). As noted above, the merchant/advertiser platform 121 can present reports as to how an advertising campaign is progressing. The reports may include information as to what the goal of the advertising campaign is (e.g., the target number of unique users or impressions to users presented advertisements to associated with the advertising campaign), time period to meet the target, groups of demographics and/or confidence levels associated with those groups, a target rate for meeting the goal over the time period (e.g., a target rate of 100,000 impressions over 10 days would set an expected rate of 10,000 impressions a day), the actual rate at which advertisements are being distributed, etc. Moreover, the merchant/advertiser platform 121 may additionally be utilized to enter input to manually adjust target user criteria or parameters (e.g., based on progress of the advertising campaign). For example, a merchant/advertiser can set or adjust a demographic based on determined click-through-rates associated with advertisements of the campaign presented to users of the UEs 103.

More specifically, the advertising platform 101 feeds the advertising engine 119 with advertisements from any number of sources (e.g., the service platform 109, services 111, the merchant/advertiser platform 121, the publisher platform 131, online advertisement stores, third party advertisement networks, etc.). In one embodiment, the advertising platform 101 may route advertisements based, at least in part, on context information (e.g., location, time, activity, etc.). In this way, the advertising platform 101 can, for instance, apply country-by-country or region-by-region rules and/or polices for presenting advertisements.

In one embodiment, the advertising platform 101 can interact with advertisement-related transactions (e.g., click through rates, advertisement buys, etc.) for reporting to end users, merchants, advertisers, publishers, and/or other users of the advertising platform 101. In addition, or alternatively, the advertising platform 101 may have an interface or other connectivity to merchant systems (e.g., point-of-sales systems) that can track coupon redemption at both online and offline merchant locations. In one embodiment, the advertising platform 101 can also collect context information, profile information, usage information, and the like from users to facilitate, for example, targeted advertising, personalization of advertisements, enriching of advertisements, etc.

In one embodiment, the advertising platform 101 can generate reports providing metrics associated with advertisement presentation, user interactions with respect to the advertisements, advertisement effectiveness, yield, and other information generated by, for instance, the other modules of the advertising platform 101.

In one embodiment, merchants/advertisers access the functions of the advertising platform 101 from the merchant/advertiser platform 121 through the merchant/advertiser API 125. For example, the merchant/advertiser platform 121 can provide a portal (e.g., a web portal or other client) for submitting advertising requests, selecting advertising means, obtaining reports, receiving advertising recommendations, and/or otherwise managing their advertisements and/or their advertising campaigns. In addition, or alternatively, it is contemplated that the advertising platform 101 can incorporate all or a portion of the functions of the merchant/advertiser platform 121 for directly interacting with merchants/advertisers.

Similarly, in one embodiment, publishers/developers access the functions of the advertising platform 101 from the publisher platform 131 via the publisher API 135. In this example, the publisher platform 131 can provide a portal for publishers to register products or applications for presenting applications, retrieving advertisements for presentation to users, generating reports, personalizing advertisements based on context, and/or any other functions of the advertising platform 101. In addition, or alternatively, it is contemplated that the advertising platform 101 can incorporate all or a portion of the functions of the publisher platform 131 for directly interacting with publishers/developers.

By way of example, the communication network 115 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 103 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 103 can support any type of interface to the user (such as ^{“}wearable” circuitry, etc.).

By way of example, the UE 103 and the advertising platform 101 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the UE 103 (e.g., the advertising engine 119), the merchant/advertiser platform 121, and/or the publisher platform 131, interact with the advertising platform 101 according to a client-server model. According to the client-server model, a client process sends a message including a request to a server process, and the server process responds by providing a service (e.g., messaging, advertisements, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

As used herein, the term “location-based service” (LBS) refers to an information service accessible through the network and utilizing the ability to make use of the geographical position of a terminal. LBS services can be used in a variety of contexts, such as navigation, entertainment, health, work, personal life, etc. Location-based services include services to identify a location of a person or object, such as discovering the nearest banking cash machine or the whereabouts of a friend or employee. Location-based services include location-based commerce (e.g., trade and repair, wholesale, financial, legal, personal services, business services, communications and media,), location-based ecommerce (e.g., online transactions, coupons, marketing, advertising, etc.), accommodation, real estate, renting, construction, dining, transport and travel, travel guides, mapping and navigation, parcel/vehicle tracking, personalized weather services, location-based games, etc.

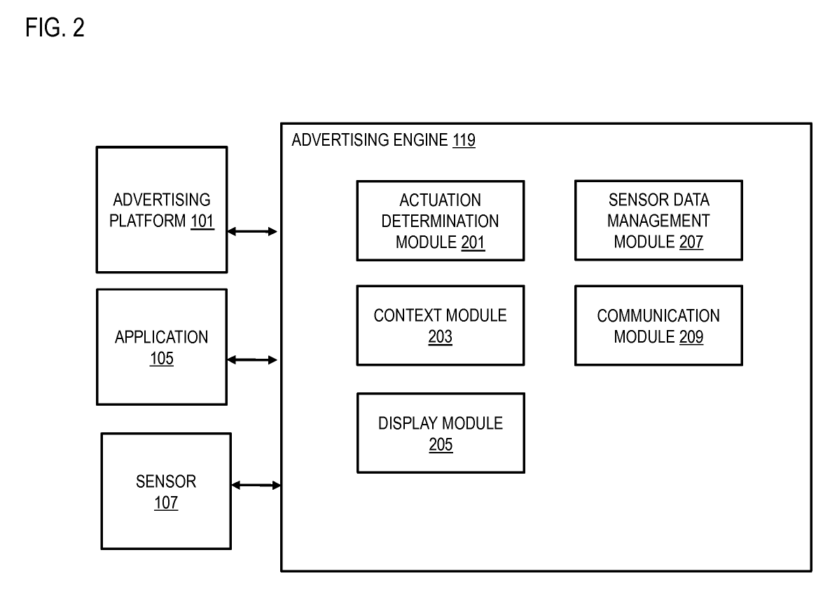

FIG. 2 is a diagram of the components of an advertising engine 119 according to one embodiment. By way of example, the advertising engine 119 includes one or more components for controlling the perspective display of advertisements using sensor data. It is contemplated that the functions of these components may be combined in one or more components or performed by other components of equivalent functionality. In this embodiment, the advertising engine 119 includes an actuation determination module 201, a context module 203, a display module 205, a sensor data management module 207, and a communication module 209.

In one embodiment, the actuation determination module 201 determines whether a user has manipulated the UE 103 in any way that may be detected by the sensors 107 of the UE 103. The manipulation may be a movement of the UE 103. The manipulation allows for the user to direct a perspective display of advertisements within an advertisement banner. The context module 203 receives context information by way of the communication module 209 about the UE 103 that may be detected by the sensors 107. By way of example, the UE 103 uses GPS, a cell ID and other techniques to measure the UE's 103 location. In other embodiments, the UE 103 has a compass or various position and orientation measuring sensors to measure an exact direction and angle where the UE 103 is turned and/or tilted.

A user profile may also be resident on the UE 103 or receivable from another network entity that communicates with the UE 103. The context information that is received may be processed by the context module 203 to determine advertisements associated with the places or locations in the proximity to the UE 103.

As used herein, the term “place” refers to the semantics/usage of a location. Although a place is always associated with a physical location, it is an object independent of the location. That is, a place (such as a restaurant, department, etc.) might change its physical location (i.e. geographic coordinates) over time, and multiple places (such as a hotel and a restaurant) might be associated with the same location. Thus, a place is associated temporally and spatially with a geographic location.

In another embodiment, the context module 203 further filters the determined advertisements based upon advertiser's targets and/or user preferences. Advertisers generally have a target audience (e.g., based on demographics) for their advertising campaigns. By way of example, the advertisements can then be provided to specific users who are members of one or more of the target demographics. In certain embodiments, demographics are characteristics of a population. Examples of demographics include age, sex, race, disabilities, mobility, education, home ownership, employment status (e.g., employed, underemployed, unemployed, etc.), location (e.g., urban, suburban, rural, etc.), income level (e.g., middle-class, upper-class, upper-middle-class, poor, etc.), military status, family status, marriage status, vehicles owned, etc. A demographic target and/or demographic group can include one or more demographics and/or demographic ranges as parameters.

The display module 205 determines what perspective view of the background image of the advertisement banner to display and what advertisement items and relevant information to be displayed with respect to the perspective view. As mentioned, an advertisement banner may present advertisement items exclusive to a particular advertiser or to a category of products or items. Based on the determination made by the actuation determination module 201, the display module 205 determines what background or view and what advertisement items are to be displayed.

The sensor data management module 207 can directly determine context information via, for instance, one or more sensors or sources of context information available at the UE 103. The sensor data management module 207 determines what sensor data is to be used for displaying a perspective view of the background of the advertisement banner for displaying what advertisement items and relevant information with respect to the perspective view.

In one embodiment, the UE 103 has a microphone for detecting sound (e.g., voice, music, noise, etc). The sound data is used by the sensor data management module 207 to control the perspective display of advertisements, including audio effects (e.g., surround sound) associated with objects in an advertisement banner.

In one embodiment, the UE 103 has a tilt sensor, a GPS receiver, a proximity sensor, a compass, an advanced gravity sensor, or a combination thereof. The position data is used by the sensor data management module 207 to control the perspective display of advertisements, including resizing and repositioning objects in an advertisement banner.

In one embodiment, the UE 103 has an ambient light sensor. The ambient light data is used by the sensor data management module 207 to control the perspective display of advertisements, including visibility and/or shading of objects in an advertisement banner.

In one embodiment, the UE 103 has a skin conductance sensor. The skin conductance data reflects emotional and/or physiological arousal of the user, and is used by the sensor data management module 207 to control the perspective display of advertisements, including changing colors of objects in an advertisement banner, for example, to make the objects look hotter if the user is exercising.

In one embodiment, the UE 103 has a temperature sensor. The temperature data is used by the sensor data management module 207 to control the perspective display of advertisements, including changing colors of objects in an advertisement banner, for example, to make the objects look cooler if the temperature is high.

The communication module 209 receives advertising data from, for instance, the advertising platform 101 or other advertisement networks available over the communication network 115. The advertising data (e.g., advertisements, information related to how and when to present advertisements, etc.) can then be stored or cached in the advertising engine 119. In one embodiment, the communication module 209 can retrieve interaction information from one or more applications (e.g., application 105, browser 117, etc.) executing at the UE 103.

In other words, the communication module 209 serves as the entry and exit points for receiving advertisements and then placing and/or handing off the advertisements to the means for presenting the advertisements (e.g., the application 105, the browser 117) at the UE 103. In one embodiment, the communication module 209 can also relay context and/or profile information to the advertising platform 101 to facilitate enriching the advertisements with personalized or other custom information. In this way, the advertisements can be more specifically targeted and/or tailored to individual characteristics and/or preferences of a user. Any processing that is done by the UE 103 may be output by the communication module 209 to the advertising platform 101 for data-mining.

As shown, the communication module 209 has connectivity to components external to the advertising engine 119; for example, the advertising platform 101, the application 105, the browser 117, and/or other like components. In one embodiment, the communication module 209 exposes its interface via standard APIs (e.g., Qt, Web Runtime (WRT), Java, etc.).

In some embodiments, the advertisements or advertising data include one or more coupons, discount information, promotions, offers, and other marketing information. Accordingly, the advertising engine 119 can parse the coupon and other similar information from the advertisements for storage. In this way, the coupon, promotion, discount, etc. is available for immediate use by the user. In one embodiment, the advertising engine 119 can also interact with a digital wallet to enable storing of the coupon or other discount information in a digital wallet or other storage external to the advertising engine 119.

In one embodiment, the advertising engine 119 collects, for instance, user interactions and/or responses to a presentation of the advertisements served through the advertising engine 119. By way of example, the advertising engine 119 may include determining click through rates, conversion rates, etc. to facilitate determination of the effectiveness of the advertisements. In some embodiments, the advertising engine 119 may perform more sophisticated monitoring of user interactions, such as tracking application use, coupon use, states changes, etc. associated with the UE 103, the applications or processes executing at the UE 103, or a combination thereof. In one embodiment, the advertising engine 119 can also monitor context changes, profile information, etc. associated with the UE 103 or a user associated with the UE 103 to, for example, facilitate the customization and/or personalization of advertisements.

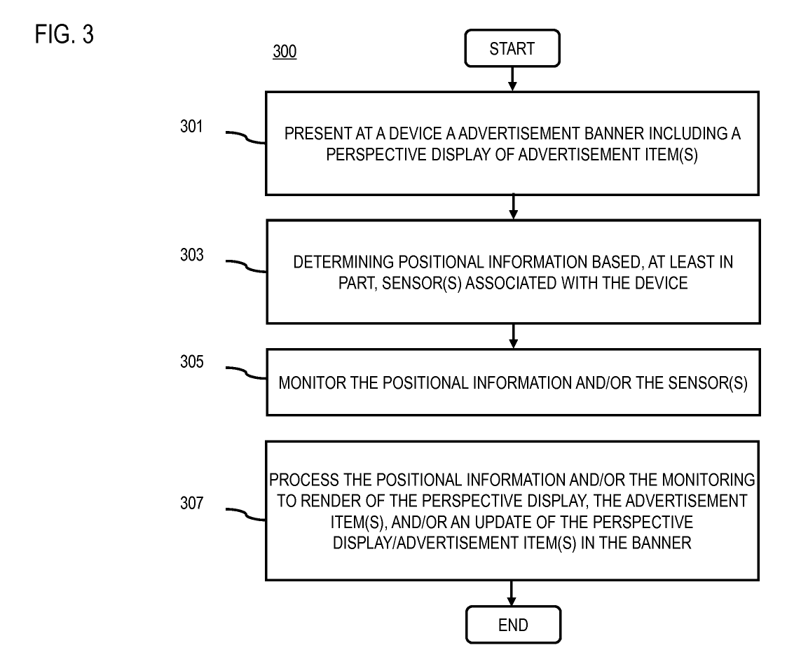

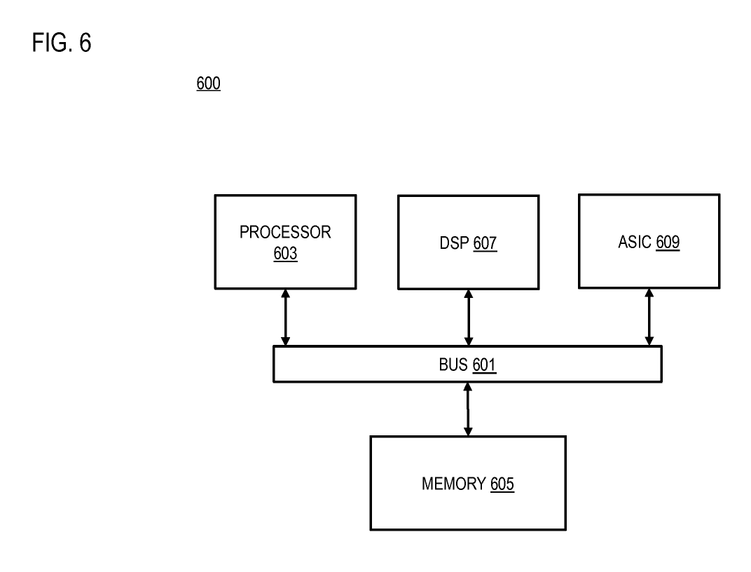

FIG. 3 is a flowchart of controlling the perspective display of advertisements using sensor data, according to one embodiment. In one embodiment, the advertising engine 119 performs the process 300 and is implemented in, for instance, a chip set including a processor and a memory as shown FIG. 6. In addition, or alternatively, all or a portion of the process 300 can be performed by the advertising platform 101, the merchant/advertiser platform 121, the publisher platform 131, or a combination thereof.

In step 301, the advertising engine 119 causes, at least in part, a presentation of at least one advertisement banner at a device (e.g., the UE 103, a device hosting API 125 of the merchant/advertiser platform 121, a device hosting API 135 of the publisher platform 131, etc.). In one embodiment, the advertisement banner includes at least one perspective display of one or more advertisement items. By way of examples, the perspective display includes, at least in part (e.g., as a background), a substantially live camera view, a prerecorded panorama view, an augmented reality view, a virtual reality view, a map view, a navigation view, or a combination thereof.

A live or substantially live camera view may be a street view, a point of interest view (e.g., Time Square in New York City, Waikiki Beach, Hawaii, Mount Shasta Volcano, Old Faithful Geyer, etc.), a traffic view, a weather view, a wildlife monitoring view (e.g., eagle's nest in Iowa, penguins in an aquarium, etc.), an environment monitoring view (e.g., Gulf of Mexico oil tracking), a border patrol view (e.g., between Texas and Mexico), a building/house internal view (e.g., a bank, a home, etc.). A prerecorded panorama view may contain the same subjects as mentioned with respect to a live or substantially live camera view.

A map view may include a urban map for navigational or real estate use (wherein elements include buildings, parking lots, etc.), a nature park map (where elements include fountains, caves, feeding grounds, etc.), a resource map (where elements include corn fields, wheat fields, oil fields, gas fields, etc.), an exhibition area map (where elements include exhibit booths, etc.), an amusement park map (where elements include theme rides, restaurants, restrooms, information desks, etc.), etc. In addition to maps of real-world locations, the map view may include a cognitive map of a virtual world (such as World of Warcraft®, Second Life®, etc.).

A navigation view can be created based upon a substantially live camera view, a prerecorded panorama view, an augmented reality view, a virtual reality view, a map view, or a combination thereof. By way of example, routes can be drawn between the elements in a map (e.g., the London Underground map, etc.) augmented with points of interest (POIs), express delivery services, emergency and government routing plans, efficient field service management, fleet operations, mobile commerce, location based services (LBS), etc.

An augmented reality view can include a background embedded with objects (e.g., advertisements) to provide a natural and easy way for the user to interact with the objects and the surrounding, yet require only minimum effort for the user to do so. The background may be a substantially live camera view, a prerecorded panorama view, a virtual reality view, a map view, a navigation view, or a combination thereof. By way of example, the background of an augmented reality view is the Old Faithful Geyser site within Yellow Stone National Park, and the background is embedded with advertisements of a professional photography service, an ice cream shop, a restaurant, etc.

A virtual reality view may contain state-of-the-art 3D models of buildings or the like in the physical world or a virtual world (e.g., restrictions in a game, physical barriers and gates, one-way streets, etc.). This degree of presentation customization has unlimited adoption based upon types and sources of user interest data. The virtual reality view may provide highlighting points of interest which are relevant to particular individuals.

In another embodiment, the advertising engine 119 determines profile information associated with the device, a user of the device or a combination thereof. The profile information of a device may include device ID, a device model number, device manufacturer name, device capacities, etc. The profile information of the user may include a user ID, preference data of the user, such as likes or dislikes food, clothing, housing, vehicles, learning, entertainments, etc. Thereafter, the advertising engine 119 processes and/or facilitates a processing of the profile information to determine the one or more advertisement items.

In one embodiment, the advertising engine 119 determines that the user has been driving on a highway for hours without stopping and the gasoline tank is low. The advertising engine 119 thus displays within a navigation application at least one advertisement banner including each restaurant next to a gas station. By way of example, the advertisement banner shows a pop-up of a restaurant and, optionally, a pop-up of a gas station in a prerecorded panorama view of the street, while the navigation application shows a navigation map of the highway.

In step 303, the advertising engine 119 determines positional information based, at least in part, on one or more sensors associated with the device. The positional information may include an exact position, an orientation, and a fixed point of view of the UE 103. Following the highway navigation example, the vehicle is five miles away from the restaurant based upon the GPS receiver of the UE 103.

In step 305, the advertising engine 119 causes, at least in part, a monitoring of the positional information, the one or more sensors, or a combination thereof. The GPS receiver of the UE 103 keeps monitoring the position of the vehicle with respect the restaurant. The sensors may include an electronic compass that gives heading information and reflects whether the UE 103 is held horizontally or vertically, a 3-axis accelerometer that gives the orientation of the UE 103 in three axes (pitch, roll and yaw) and determines types of movements (such as running, jumping etc. since these actions cause specific periodic accelerations), or a gyroscope that reads an angular velocity of rotation to capture quick head rotations.

In step 307, the advertising engine 119 processes and/or facilitates a processing of the positional information and/or the monitoring to cause, at least in part, a rendering of the at least one perspective display, the one or more advertisement items, an update of the at least one perspective display, the advertisement item, or a combination thereof in the at least one advertisement banner. As previously noted, the advertisements items presented in the advertisement banner may be exclusive to one advertiser, multiple advertisers, multiple item categories, etc. The monitoring, the update, or a combination thereof is performed in at least substantially real time, periodically, according to a schedule, on demand, or a combination thereof. By way of the highway navigation example, as the vehicle is moving, the distance data in the pop-ups of the restaurant and the gas station changes accordingly. In another embodiment, the perspective of the panorama street view gradually moves from sideway toward the center according to the driving speed of the vehicle.

Therefore, the presentation of the at least one advertisement banner, the at least one perspective display, the one or more advertisement items, or a combination thereof are based, at least in part, on configuration information (e.g., of the UE 103), preference information (e.g., of the user, a user group, a community, a publisher, a group of publishers, etc.), or a combination thereof associated with one or more advertisers.

In another embodiment, the advertising engine 119 determines contextual information associated with the device, the one or more advertisement items, or a combination thereof. The contextual information associated with the device may include a distance between the UE 103 and the one or more advertisement items (e.g., a coffee shop), a tilted angle of the UE 103 with respect to the advertisement item (e.g., the UE 103's back surface set at 45 degrees towards the front door of the coffee shop), an approach speed at a predetermined direction toward the advertisement item (e.g., 3 mile/hr from the north), a route the UE 103 took when approaching the advertisement item as well as the time, current activity, weather, etc. associated with the user. The contextual information associated with the advertisement items may include objects (e.g., products/services), agents (e.g., merchants/advertisers), occurrences (e.g., serving circumstances, events, processes, actions, activities, accomplishments, etc.), purposes (e.g., mandates, norms, values, intentions, rules, standards, virtues, functions, brand loyalty, purchases, etc.), time (e.g., when to serve), places, forms of expression (e.g., text, graphic, audio, video, 3D, avatar, etc.), concepts/abstraction, relationship, etc.

Thereafter, the advertising engine 119 processes and/or facilitates a processing of the contextual information to determine the perspective display, the one or more advertisements items, or a combination thereof. The presentation of the at least one advertisement banner is based, at least in part, on the contextual information. Using the coffee shop example, when a distance between the UE 103 and the coffee shop reaches a predefined range (e.g., 10 meters), the perspective display switches to a prerecorded panorama street view that centers at the coffee shop and includes a pop-up of a special promotion item of the coffee shop. As another example, when the orientation of the UE 103 is tilted in such a way that it's back surface is vertically aligned to exterior of the coffee shop, the perspective display switches to a live camera view inside the coffee shop, and a virtual cashier of the coffee shop is augmented in the live camera view for taking orders.

In another embodiment, the advertising engine 119 receives an input (e.g., touching a screen of the UE 103, typing into a filed on the screen, etc.) for specifying a user interaction with the at least one advertisement banner. Thereafter, the advertising engine 119 processes and/or facilitates a processing of the input, the user interaction, or a combination thereof to determine one or more actions associated with the at least one advertisement banner, the at least one perspective display, the one or more advertisement items, or a combination thereof.

The advertising engine 119 then causes, at least in part, an initiation of the one or more actions based, at least in part, on the input, the user interaction, or a combination thereof. The one or more actions include, at least in part, an expansion of the perspective display (e.g., a bigger size and/or representation), another presentation of additional information related to the one or more advertisement items (e.g., more detailed description, etc.), an establishment of a communication session with at least one party associated with the one or more advertisement items (e.g., using Twitter®, instant messaging, etc. to order the items), or a combination thereof.

For example, referring back to the coffee shop example, a virtual order (e.g., one cappuccino and an egg sandwich) is activated and auto-completed when a user talks to the virtual cashier of the coffee shop shown on the screen of the UE 103 via a built-in microphone and a voice recognition application. The microphone receives user's voice input and the voice recognition application converts the voice into content data for the UE 103 to transmit directly to a coffee shop server via a near field communication channel (e.g., radio frequency signals, Bluetooth, etc.), or via the communication network 115 and the advertising platform 101. The coffee shop server may be connected with the merchant/advertiser platform 121, the publisher platform 131, or a combination thereof.

While the user is waiting for the food and coffee in the coffee shop, the coffee shop server communicates with the advertising engine 119 and detects that the UE 103 is installed with an interactive game application that the coffee shop has contracted to promote as a publisher and has right to insert its own advertisements in the game application as a merchant/advertiser. The coffee shop server further communicates with the advertising engine 119 to activate the interactive game application at the UE 103, and/or to display an advertisement banner in the game application with desired advertisement items of the coffee shop, such as coffee mugs, T-shirts, etc.

In another embodiment, the game application is integrated with the advertisement items such that when the user acts in certain ways in the game or in the physical world, an advertisement item becomes visible. By way of example, when the user carrying the UE 103 jumps up and down, punches in the air, etc., in the coffee shop, these conditions can be detected by sensors 107 and trigger in the advertisement banner a pop-up of, for example, a 10% discount coupon for a coffee mug or for a new game application.

In addition to a condition that the user is in a particular place, other conditions (e.g., a speed, a direction of movement, a type of movement: jumping, running, etc.) can be determined by sensors 107 as well. For example, in an augmented reality game where the user is required to run to discover some puzzle or clue, the advertising engine 119 determines the running speed of the user by an accelerometer o the UE 103. In another example, when the user is required to jump in a particular place to break a virtual box, the jumping location is also determined by the accelerometer. In yet another example, when the user is required to spin to trigger an advertisement item, the spinning is measured with a gyroscope. In another embodiment, the advertisement item becomes visible only when in an exact GPS reported position and combined readings of the accelerometer, and the gyroscope, and a compass over time are met.

In these cases, a computer vision can be used for object recognition (e.g., “knock on the coffee table”) and for improving the accuracy of the advertising engine 119. There are state of the art computer vision algorithms which include feature descriptor approaches for assigning scale and rotation invariant descriptors to an object. For example, scale-invariant feature transform (SIFT) is an algorithm in computer vision to detect and describe local features in images. Speeded up robust features (SURF) is a robust image detector and descriptor used in computer vision tasks like object recognition or 3D reconstruction. In another embodiment, fast “optical flow” algorithms can be deployed to determine which direction the UE 103 appears to be rotating in order to confirm the sensor reported rotations.

In another embodiment, the advertising engine 119 causes, at least in part, tracking of user interaction information in response to the presentation of the one or more advertisement items. In this way, the advertising engine 119 provides for continuous interaction with the UE 103 to provide for presentation and tracking of related advertisement items and to tailor the advertising experience to the continuing actions taken by the user.

It is contemplated that the one or more results, the at least one merchant, the one or more advertisement items, the user interaction, or a combination thereof relate to online commerce, offline commerce, or a combination thereof. More specifically, the advertising engine 119 and/or the advertising platform 101 can determine whether the user takes any action in response to the presentation of the advertisement item. For example, the advertising engine 119 can track whether the user has clicked on the advertisement item or made a purchase/order in response to the advertisement item.

The advertising engine 119 optionally generates reports regarding metrics associated with, for instance, presentation of the advertisement items, effectiveness of the advertisement items (e.g., click through rates, conversion rates), use interaction information, user characteristics, and other information collected and/or used by the advertising platform 101 or other components of the system 100 for customizing advertisements and/or advertisement campaigns.

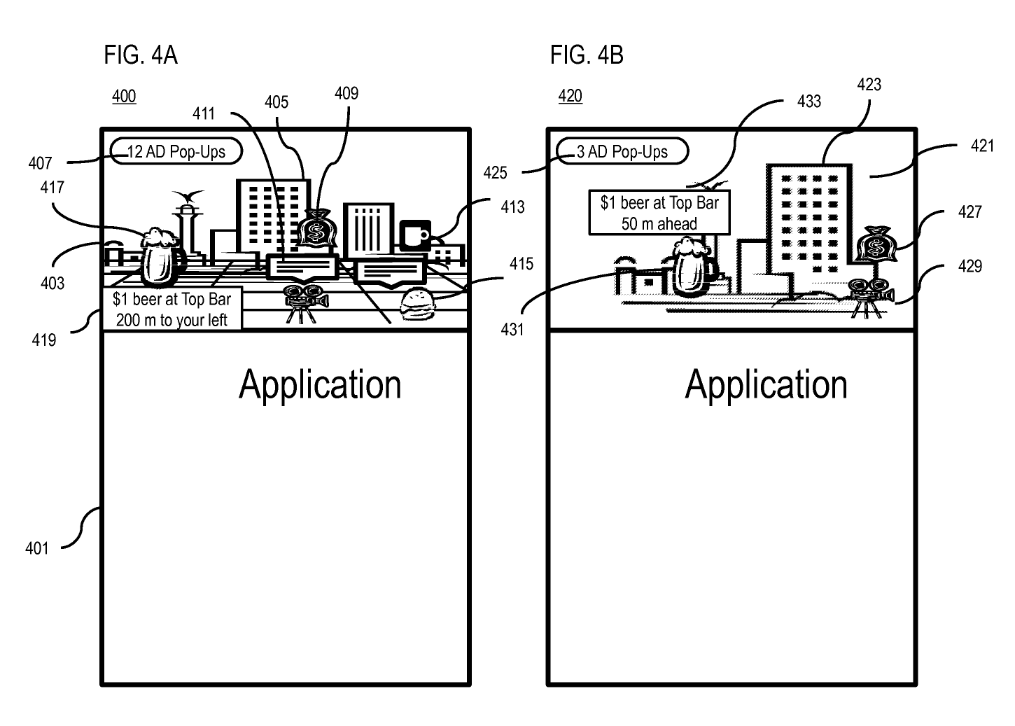

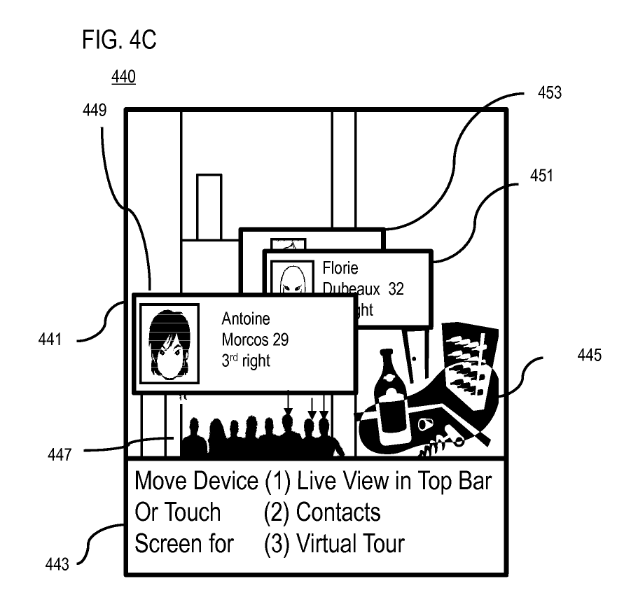

FIGS. 4A-4C are diagrams of user interfaces utilized in the process of FIG. 3, according to various embodiments. The user interfaces of FIGS. 4A-4C represent a sample use case of presenting advertisement items in an advertisement banner with different perspectives in response to the UE 103 sensor data to promote discovery and consumption of advertisement items.

In one embodiment, the UE 103 determines an application currently executing on the UE 103, history of application usage, content currently being rendered on the UE 103, user input through a user interface (UI), and/or other user interactions determined at the UE 103. In FIG. 4A, an application currently executing on the UE 103 is a game application.

The user interface 400 illustrates an application area 401 that displays the game and an advertisement banner area 403 on top of the game application area 401. The advertisement banner area 403 illustrates a background 405 which is a live view of a city skyline, and a field 407 that indicates a total number (e.g., 12) of sponsored advertisement items (e.g., icons, pop-ups, etc.) within in the live view.

In this example, the advertisement banner presents multiple advertisement items as represented by a bank icon 409, a movie theater icon 411, a coffee shop icon 413, a burger shop icon 415, and a bar icon 417. It is noted that in other examples, the presented advertisement items may be limited exclusively to a particular advertiser.

When the user selects the bar icon 417, the icon is highlighted and a pop-up 419 is displayed to provide additional information or offers. In this example, the pop-up 419 reads “$1 beer at Top Bar 200 meters to your left.” In some embodiments, the pop-up 419 can be displayed as soon as the associated location (e.g., as indicated by the bar icon 417) comes within the field of view of the advertisement banner 403. In other embodiments, the pop-up 419 can be displayed in place of the bar icon 417, so that the advertisement message represents the advertisement item in the advertisement banner 403. In other words, it is contemplated that the system 100 can use any user interface element or combination of elements (e.g., an icon, a message box, a multimedia file, a rendered 3D object, etc.) to represent or otherwise indicate the relative position of an advertisement item (e.g., the bar associated with the bar icon 417 and the pop-up 419) in the advertisement banner 403.

In one embodiment, once an advertisement message (e.g., “$1 beer at Top Bar 50 m ahead”) is triggered, it remains displayed in the advertisement banner 403. In another embodiment, after an advertisement message is displayed, it may be replaced with more detailed advertisement information or removed from the advertisement banner based, at least in part, on the interaction between the UE 103. By way of example, as the user moves towards the bar and reaches within a predetermined distance (e.g., 50 meters) from the bar, the user interface switches to the one shown in FIG. 4B.

The user interface 420 continues illustrating the game application and the advertisement banner 421 on top of the game application area 401. The advertisement banner 421 can automatically change from the live view discussed above to a background 423 which is a prerecorded panorama view of the city skyline with the bar at the center, and a field 425 that indicates a total number (e.g., 3) of sponsored advertisement items included in the panorama view. In this view, the advertisement items include a bank icon 427, a movie theater icon 429, and a bar icon 431. Again, as noted above, the advertisement banners in some embodiments are exclusive to specific advertisers or limited to fewer categories of advertisement items. As the UE 103 moves closer to the bar, the building, the background and the icons appear larger than in FIG. 4A to reflect the detected movement of the UE 103. In addition, the associated pop-up 433 (e.g., presenting an advertisement message that reads “$1 beer at Top Bar 50 m ahead”) is rendered in at least the approximate location of the bar as shown in the panorama view. As movement is detected at the UE 103, the panorama view and the objects within the view are moved (e.g., panned, tilted, zoomed, etc.) accordingly.

In addition, when the user selects the bar icon 433 or the pop-up 433 in FIG. 4B, the advertising engine 119 directs the user interface to an online store associated with the bar as shown in FIG. 4C. The user interface 440 represents a landing page of the bar website. The landing page illustrates a bar view area 441 that displays different views inside the Bar and a user instruction area 443 under the bar view area 441. The user instruction area 443 shows instructions including “Move device or touch screen for: (1) live view in Top Bar, (2) contacts, (3) virtual tour.”

When the user selects a bar image 445, the advertising engine 119 directs the user interface to a live view in the bar. When the user selects a contact image 447, the advertising engine 119 displays one or more pop-ups (e.g., V-cards) of guests in the bar.

In another embodiment, a V-card of a guest is viable only if the guest make it publicly viewable or viewable to selected individuals. The advertising engine 119 may contact the UE 103 of the guest or a social network to verify whether the user is authorized to view the guest's V-card.

The advertising engine 119 tracks user interaction with respect to the advertisement item to change the display. In one embodiment, the v-cards 449, 451, 453 stay visible on the user interface 440 once the user is verified. The advertising platform 101 continues to track the user behavior and continues to present relevant or appropriate advertisements. In another embodiment, the v-card stays visible on user the interface 440 once the user is verified and only when the UE 103 points towards the guest's direction.

The above-discussed embodiments display an advertisement banner including a background embedded with objects (e.g., advertisement items) to provide a natural and easy way for the user to interact with the objects and the surrounding, yet require minimum user effort by using sensor data.

The processes described herein for controlling perspective display of advertisement using sensor data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

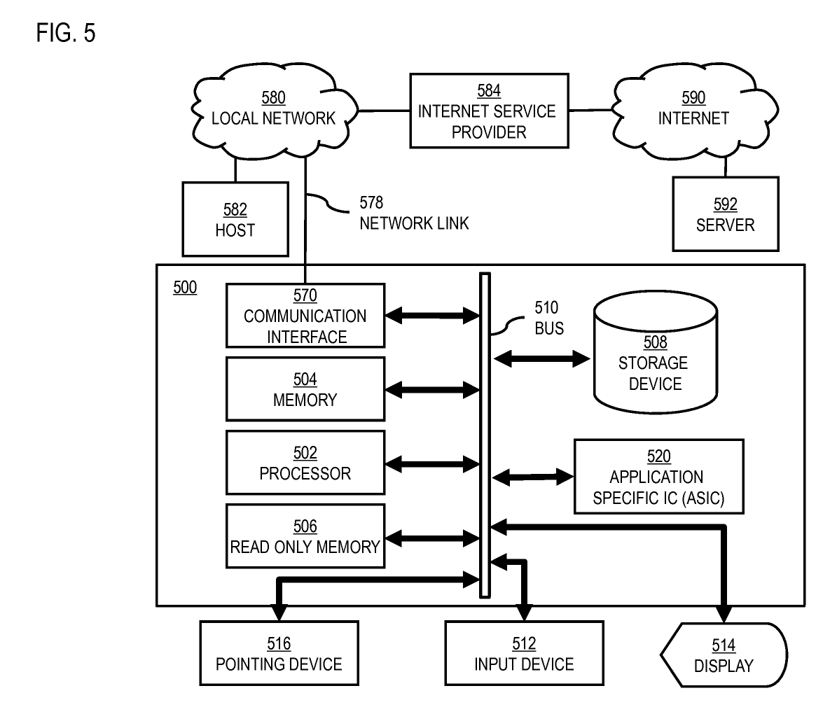

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to control perspective display of advertisement using sensor data as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of controlling perspective display of advertisement using sensor data.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to control perspective display of advertisement using sensor data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for controlling perspective display of advertisement using sensor data. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for controlling perspective display of advertisement using sensor data, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection between UE 103 and the communication network 115 for controlling perspective display of advertisement using sensor data.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to control perspective display of advertisement using sensor data as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of controlling perspective display of advertisement using sensor data.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to control perspective display of advertisement using sensor data. The memory 605 also stores the data associated with or generated by the execution of the inventive steps.

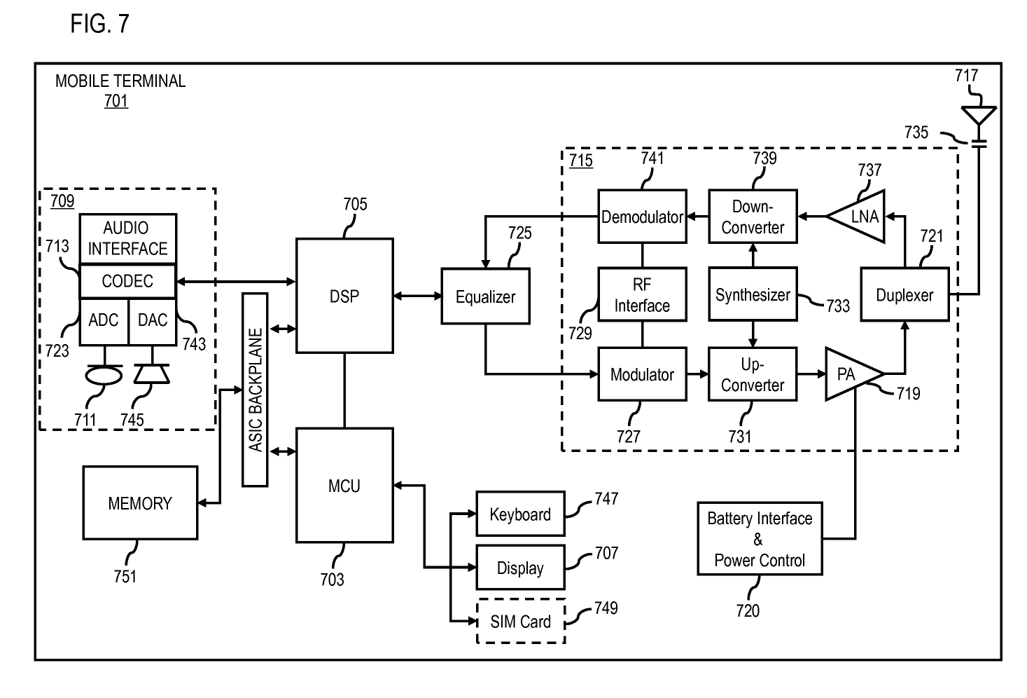

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of controlling perspective display of advertisement using sensor data. Generally, a radio receiver is often defined in terms of front-end and back- end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of controlling perspective display of advertisement using sensor data. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to control perspective display of advertisement using sensor data. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non- volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a presentation of at least one advertisement banner at a device, the advertisement banner including at least one perspective display of one or more advertisement items;
positional information based, at least in part, on one or more sensors associated with the device; and
a processing of the positional information to cause, at least in part, a rendering of the at least one perspective display, the one or more advertisement items, or a combination thereof in the at least one advertisement banner.

2. A method of claim 1, wherein the (1) data and/or (2) information and/or (3) at least one signal are further based, at least in part, on the following:
a monitoring of the positional information, the one or more sensors, or a combination thereof; and
a processing of the monitoring to cause, at least in part, an update of the at least one perspective display, the one or more advertisement items, or a combination thereof.

3. A method of claim 2, wherein the monitoring, the update, or a combination thereof is performed in at least substantially real time, periodically, according to a schedule, on demand, or a combination thereof.

4. A method of claim 1, wherein the (1) data and/or (2) information and/or (3) at least one signal are further based, at least in part, on the following:
contextual information associated with the device, the one or more advertisement items, or a combination thereof,
wherein the presentation of the at least one advertisement banner is based, at least in part, on the contextual information.

5. A method of claim 4, wherein the (1) data and/or (2) information and/or (3) at least one signal are further based, at least in part, on the following:
a processing of the contextual information to determine the perspective display, the one or more advertisements items, or a combination thereof.

6. A method of claim 1, wherein the (1) data and/or (2) information and/or (3) at least one signal are further based, at least in part, on the following:
an input for specifying a user interaction with the at least one advertisement banner;
a processing of the input, the user interaction, or a combination thereof to determine one or more actions associated with the at least one advertisement banner, the at least one perspective display, the one or more advertisement items, or a combination thereof; and
an initiation of the one or more actions based, at least in part, on the input, the user interaction, or a combination thereof.

7. A method of claim 6, wherein the one or more actions includes, at least in part, an expansion of the perspective display, another presentation of additional information related to the one or more advertisement items, an establishment of a communication session with at least one party associated with the one or more advertisement items, or a combination thereof.

8. A method of claim 1, wherein the at least one perspective display includes, at least in part, a substantially live camera view, a prerecorded panorama view, an augmented reality view, a virtual reality view, a map view, a navigation view, or a combination thereof.

9. A method of claim 1, wherein the (1) data and/or (2) information and/or (3) at least one signal are further based, at least in part, on the following:
profile information associated with the device, a user of the device or a combination thereof; and
a processing of the profile information to determine the one or more advertisement items.

10. A method of claim 1, wherein the presentation of the at least one advertisement banner, the at least one perspective display, the one or more advertisement items, or a combination thereof are based, at least in part, on configuration information, preference information, or a combination thereof associated with one or more advertisers.

11. An apparatus comprising:
at least one processor; and
at least one memory including computer program code for one or more programs, the at least one memory and the computer program code configured to, with the at least one processor, cause the apparatus to perform at least the following,
cause, at least in part, a presentation of at least one advertisement banner at a device, the advertisement banner including at least one perspective display of one or more advertisement items;
determine positional information based, at least in part, on one or more sensors associated with the device; and
process and/or facilitate a processing of the positional information to cause, at least in part, a rendering of the at least one perspective display, the one or more advertisement items, or a combination thereof in the at least one advertisement banner.

12. An apparatus of claim 11, wherein the apparatus is further caused to:
cause, at least in part, a monitoring of the positional information, the one or more sensors, or a combination thereof; and
process and/or facilitate a processing of the monitoring to cause, at least in part, an update of the at least one perspective display, the one or more advertisement items, or a combination thereof.

13. An apparatus of claim 12, wherein the monitoring, the update, or a combination thereof is performed in at least substantially real time, periodically, according to a schedule, on demand, or a combination thereof.

14. An apparatus of claim 11, wherein the apparatus is further caused to:
determine contextual information associated with the device, the one or more advertisement items, or a combination thereof,
wherein the presentation of the at least one advertisement banner is based, at least in part, on the contextual information.

15. An apparatus of claim 14, wherein the apparatus is further caused to:
process and/or facilitate a processing of the contextual information to determine the perspective display, the one or more advertisements items, or a combination thereof.

16. An apparatus of claim 11, wherein the apparatus is further caused to:
receive an input for specifying a user interaction with the at least one advertisement banner;
process and/or facilitate a processing of the input, the user interaction, or a combination thereof to determine one or more actions associated with the at least one advertisement banner, the at least one perspective display, the one or more advertisement items, or a combination thereof; and
cause, at least in part, an initiation of the one or more actions based, at least in part, on the input, the user interaction, or a combination thereof.

17. An apparatus of claim 16, wherein the one or more actions includes, at least in part, an expansion of the perspective display, another presentation of additional information related to the one or more advertisement items, an establishment of a communication session with at least one party associated with the one or more advertisement items, or a combination thereof.

18. An apparatus of claim 11, wherein the at least one perspective display includes, at least in part, a substantially live camera view, a prerecorded panorama view, an augmented reality view, a virtual reality view, a map view, a navigation view, or a combination thereof.

19. An apparatus of claim 11, wherein the apparatus is further caused to:
determine profile information associated with the device, a user of the device or a combination thereof; and
process and/or facilitate a processing of the profile information to determine the one or more advertisement items.

20. An apparatus of claim 11, wherein the presentation of the at least one advertisement banner, the at least one perspective display, the one or more advertisement items, or a combination thereof are based, at least in part, on configuration information, preference information, or a combination thereof associated with one or more advertisers.
